(19) United States
(12) Patent Application Publication
(10) Pub. No.: US 2020/0271590 A1
(43) Pub. Date: Aug. 27, 2020

(54) RAPID JOINT DETECTION DEVICE AND DETECTION METHOD FOR DETERIORATION DEGREE OF FRIED OIL

(71) Applicant: JIANGNAN UNIVERSITY, Wuxi, Jiangsu (CN)

(72) Inventors: Min ZHANG, Wuxi, Jiangsu (CN); Ya SU, Wuxi, Jiangsu (CN); Jianhong YIN, Wuxi, Jiangsu (CN); Chunquan LIU, Wuxi, Jiangsu (CN); Weiming ZHANG, Wuxi, Jiangsu (CN)

(21) Appl. No.: 16/620,820

(22) PCT Filed: Jun. 27, 2018
(86) PCT No.: PCT/CN2018/093128

§ 371 Date: Dec. 9, 2019

(30) Foreign Application Priority Data
Feb. 27, 2018 (CN) 201810163929.4

(51) Int. Cl. G01N 21/80; G01N 27/22

(52) U.S. Cl. CPC G01N 21/80; G01N 2021/7759; G01N 27/221

(57) ABSTRACT

A rapid joint detection device and detection method for deterioration degree of fried oil belongs to the technical field of rapid detection of food quality and safety. The acid value and the peroxide value of the fried oil are used as major indexes for measuring the deterioration degree of the fried oil to make a micro-thin layer chromatography test paper strip that can develop colors according to different deterioration degrees of the fried oil; through the color development analysis of the test paper strip, and in combination with the dielectric constant value of the fried oil, the color difference value of developed colors of the test paper strip color is converted into the data of the acid value and the peroxide value data of the fried oil.

### TECHNICAL FIELD

The present invention relates to a rapid joint detection device and detection method for deterioration degree of fried oil, and belongs to the technical field of rapid detection of food quality and safety.

### BACKGROUND

Fried oil contains important nutrients that human bodies cannot synthesize but are indispensable. It can improve the sensory properties of the food during the processing of fried food to obtain the unique flavor and taste of the fried products. The fat in the diet is also conducive to absorbing fat-soluble vitamins and providing essential fatty acid, and is an important part of human dietary nutrition. With the intensification of economic globalization and the improvement of human awareness of healthy diet, food safety has affected the production and trade process of international food and has become one of focus issues of the international community. Moreover, with the improvement of the mechanization level of enterprise production, the search for a novel, rapid, accurate and intelligent detection method for the deterioration degree of fried oil is a long-term concerned and urgent problem to be solved in mechanized intelligent production and food safety guarantee of modern enterprises.

The traditional identification and detection instruments for the quality of the fried oil are expensive and also extremely cumbersome in operation and maintenance. Due to non-portability, the instruments are not suitable for rapid and accurate detection requirements in the mechanized production process of the enterprises and other detection departments. Therefore, it is of great significance to develop a corresponding rapid detection method for the deterioration degree of the fried oil, to accelerate and improve the mechanization and intellectualization process of enterprise production, develop rapid detection standards for the quality of the fried oil and realize production and safety control of food enterprises.

At present, many research reports have been made on the evaluation method of the deterioration degree of the fried oil, but a globally recognized detection method has not been determined, and different methods and standards are also used in different use places. At present, the detection methods used by detection institutions or manufacturers in China mainly include a test paper method, a titration method, a mass spectrometry method, a gas chromatography method, a nuclear magnetic resonance method, a conductivity method, an electronic nose and an electronic tongue method.

Zheng Xiao et al. (Publication No.: CN 103983606 A) disclose a portable near-infrared edible oil quality rapid detector. A main control system provided by the detector intelligently controls the temperature of edible oil in a constant temperature sample cell, effectively reduces the influence of the temperature on a spectrogram of the edible oil to be detected, and intelligently controls the spectrogram of the edible oil in the sample cell collected by a near-infrared spectrometer. Finally, the collected atlases are rapidly analyzed by analysis software in the main control system to achieve rapid site detection for the quality of the edible oil. The difference of the present invention is that the defects of high sampling requirement and low repeatability of an infrared device are overcome; and the sampling is convenient, simple and good in reproducibility.

Tang Xinhua (Publication No.: CN 104949947 A) invents a rapid detection method for quality of edible oil. The method establishes a correlation equation between the fluorescence value of edible oil excited by 365 nm light source and the nutrient component in the edible oil. When the fluorescence value is judged to be 100, the quality of the edible oil is determined to be qualified. Tu Bin (2016) researches a method for detecting edible oil varieties, peanut oil adulterated content and authenticity, and fatty acid composition content through a multi-source spectral data fusion technology using laser Raman and laser near-infrared spectroscopy and in combination with a chemometrics method. A model for rapid identification of edible oil varieties, edible oil adulteration and quantitative prediction of fatty acid content based on Raman and near-infrared multi-source spectral data fusion technology is established. The differences of the present invention are that large and expensive instruments and cumbersome pre-processing manner are avoided, the operation is simple, and the cost of the detection device is reduced.

Li Jing et al. (2013) research a PEN3 type electronic nose system used to analyze the quality change rule of soybean salad oil during high-temperature frying, which obtains that it is feasible to use the electronic nose system to rapidly analyze and identify the freshness degree and quality of the fried oil. Zhang Hang et al (2013) research a method for rapidly detecting doped palm oil in camellia seed oil by using an electronic tongue sensor, and the obtained sample data are analyzed by principal components, discrimination factors and the similarity method. The results show that when the ZZ and GA sensors are selected, the discrimination index of the principal component analysis chart reaches 87, which can clearly identify a small proportion of doped camellia seed oil and indicate that the electronic tongue has a broad application prospect in oil detection. The differences of the present invention are that the quality of the fried oil is rapidly and visually detected by using the rapid color developing test paper, the numerical parameters of the acid value and the peroxide value of the fried oil are represented more visually and accurately through the combination of the color difference value of the color developing test paper and the dielectric properties of the fried oil, and the quality of the fried oil is discriminated more accurately.

Wang Le (2008) researches a color card of color developing test paper for the quality of different edible oil made by using thin-layer chromatography color developing test paper and the edible oil with different contents of food waste oil in the research of identification and detection of waste oil-doped edible oil in the catering industry, for the discrimination of the edible oil. The differences of the present invention are that the dielectric property of the fried oil is combined with the color difference value of the color developing test paper to establish the correlation equation between the acid value and the peroxide value of the fried oil, thereby overcoming the error caused by the intuitive judgment and accurately and rapidly obtaining the quality index value of the fried oil.

Zhao Yuanli et al. (2012) design a detector for detecting polar components of fried oil through a sensor method. The detector uses an interdigital electrode type capacitive sensor to detect the change of the dielectric constant of the fried oil. A capacitance/frequency conversion circuit converts the change of the capacitance into a frequency form convenient for measurement, and the measured change of the output frequency reflects the change of the dielectric constant of the fried oil. Ma Rongchao et al. (Publication No.: CN 202305460 U) invent a rapid detector for edible oil quality based on dielectric properties. A capacitive sensor is put in oil to be detected. A mathematical model is embedded in a signal converter for signal conversion. After the button is operated for 15 seconds, four index parameter values of the sample can be displayed, and the alarm is selected according to the set value. The differences of the present invention are that the color development reaction of the rapid detection test paper is used to more intuitively detect the quality features of the fried oil, and the correlation equation with the dielectric properties of the fried oil is used to improve the accuracy of the quality detection of the fried oil.

Although many detection methods are used for detecting the quality of the fried oil currently, the methods have the main problems: time consuming of sample pre-processing such as separation and extraction; expensive price, complicated operation, time consuming and labor consuming of the instrument device; adverse effects of organic reagents on the environment and human health; long time consuming, complicated operation and poor result reproducibility; generally large instruments with good performance, which makes it impossible to realize the combination of functions and convenient carrying and difficult to realize high performance price ratio of the detector; inapplicability to requirements of modern society for rapid, accurate and intelligent detection of food safety. In the process of food processing and production, in order to ensure the quality and hygiene of the edible oil, it is of great significance to develop a rapid, effective, convenient, simple, low-cost, non-destructive and accurate detection method. The present invention develops rapid detection test paper for indicating the deterioration degree of the fried oil by detecting the change of the acid value and the peroxide value in the deterioration process of the fried oil. By combining the detection result of the color difference value of developed colors of the test paper with the dielectric constant value of the fried oil, the color difference value of the developed colors of the test paper is converted into the data of the acid value and the peroxide value of the fried oil; and then the deterioration degree of the fried oil is rapidly detected. The present invention has the characteristics of simplicity, rapidness, accuracy, convenience, low cost, high sensitivity, no destruction and intelligence, is suitable for the rapid detection of the deterioration degree of the fried oil in production and detection departments of enterprises, and has broad development prospects.

### SUMMARY

The purpose of the present invention is to overcome the above defects to provide a rapid color development-dielectric joint detection device and detection method for deterioration degree of fried oil.

According to the technical solution provided by the present invention, the rapid joint detection device for deterioration degree of fried oil comprises rapid detection test paper for quality of fried oil, a dropper, a color difference meter, a dielectric analyzer and a sample to be detected; the sample to be detected is connected with the dielectric analyzer; the dropper is used for sucking the sample to be detected and dropping the sample to be detected on the rapid detection test paper for quality of fried oil for detection; and the rapid detection test paper for quality of fried oil is connected with the color difference meter.

The rapid detection test paper for quality of fried oil comprises a carrier and a color developing layer covered on the carrier.

A preparation method of the rapid detection test paper for quality of fried oil comprises the following steps:

(1) carrier preparation: using a transparent frosted plastic sheet as the carrier;

(2) preparation of the color developing layer: weighing 5 g of G-type thin-layer chromatography silica gel, adding 20 mL of sodium carboxymethyl cellulose solution with a mass concentration of 0.3% to the silica gel, and evenly grinding in a mortar; uniformly applying the ground solution to the carrier in the step (1), placing for 3-5 hours at room temperature to dry, and finally immersing the carrier in a bromocresol green indicator for dyeing, to obtain the rapid detection test paper for quality of fried oil.

A rapid joint detection method for deterioration degree of fried oil adopts color development-dielectric joint detection and comprises the steps:

(1) determining the dielectric feature of the sample to be detected by the dielectric analyzer; analyzing and predicting the quality of the sample to be detected; and reducing the identification accuracy of the color developing test paper of the fried oil by a correlation equation established among an acid value of the fried oil, a peroxide value and the dielectric eigenvalue of the fried oil established in an early test;

(2) taking 1-2 mL of the sample to be detected with the dropper, evenly applying to the rapid detection test paper for quality of fried oil, and waiting for 10 s to develop a color; observing the color change of the rapid detection test paper for quality of fried oil, and reading a color difference value through the color difference meter;

(3) rapidly detecting the deterioration degree of the fried oil through the obtained actual data of the acid value of the fried oil, the peroxide value and the color difference value ΔE(x).

Correlation analysis is conducted on the acid value of the fried oil, the peroxide value and the color difference value ΔE(x) to obtain the correlation equation, wherein a linear equation obtained by using the acid value of the fried oil as a y axis and the color difference value ΔE as an x axis is y=0.346x−6.247, and a correlation coefficient R² is 0.988; a linear equation obtained by taking the peroxide value as the y axis and the color difference value ΔE as the x axis is y=0.090x+0.486, and a correlation coefficient R² is 0.985;

the correlation is established among the acid value of the fried oil, the peroxide value and the dielectric eigenvalue ε(x) of the fried oil to obtain a correlation equation, wherein a linear equation obtained by using the acid value of the fried oil as a y axis and the dielectric eigenvalue ε as an x axis is y=1.186x−2.356, and a correlation coefficient R² is 0.979; a linear equation obtained by taking the peroxide value as the y axis and the dielectric eigenvalue ε as the x axis is y=0.303x+1.510, and a correlation coefficient R² is 0.975.

The method shows through multiple experiments that the accuracy rate of detecting the acid value of the fried oil sample is 98.7%, which indicates that the rapid detection method has high accuracy rate and good repeatability and can play the role of site rapid screening of the fried oil sample. Although the accuracy rate of the rapid detection method is less than 100%, the rapid detection analyzer used in the experiment uses a color difference sensor and the analysis of the dielectric constant of the fried oil, which overcomes the cumbersome procedure of national standard method laboratory detection, reduces experimental cost, also overcomes the intuitive error of visual inspection by the naked eye, realizes the qualitative and quantitative detection of tested substances, and meets the requirements of simple, rapid, intelligent and site detection.

The present invention has the beneficial effects: the method of the present invention develops the rapid detection test paper for indicating the deterioration degree of the fried oil by detecting the change of the acid value and the peroxide value in the deterioration process of the fried oil. Through the combination of the data of the color difference value read by the color difference meter and the dielectric constant of the fried oil, the correlation equation is established to obtain the actual data of the acid value and the peroxide value of the fried oil; and then the deterioration degree of the fried oil is rapidly detected jointly.

The present invention has the characteristics of simplicity, rapidness, accuracy, convenience, low cost and high sensitivity, is suitable for the rapid detection of the deterioration degree of the fried oil in production and detection departments of enterprises, has broad development prospects and simple and rapid operation in the whole process, greatly improves the working efficiency of detection and analysis personnel and is conducive to food companies to improve the mechanization degree of production. The method has stable performance, high accuracy rate and low cost, and is suitable for rapid site detection of the deterioration degree of the fried oil.

### DESCRIPTION OF DRAWINGS

FIG. 1 is a schematic diagram of components of a test device of the present invention.

FIG. 2-a is a schematic diagram of analysis results of an acid value and a color difference value ΔE(x) of fried oil.

FIG. 2-b is a schematic diagram of analysis results of a quality index value of a peroxide value and a color difference value ΔE(x).

FIG. 3-a is a schematic diagram of analysis results of an acid value and a dielectric eigenvalue ε(x) of fried oil.

FIG. 3-b is a schematic diagram of analysis results of a quality index value of a peroxide value and a dielectric eigenvalue ε(x) of fried oil.

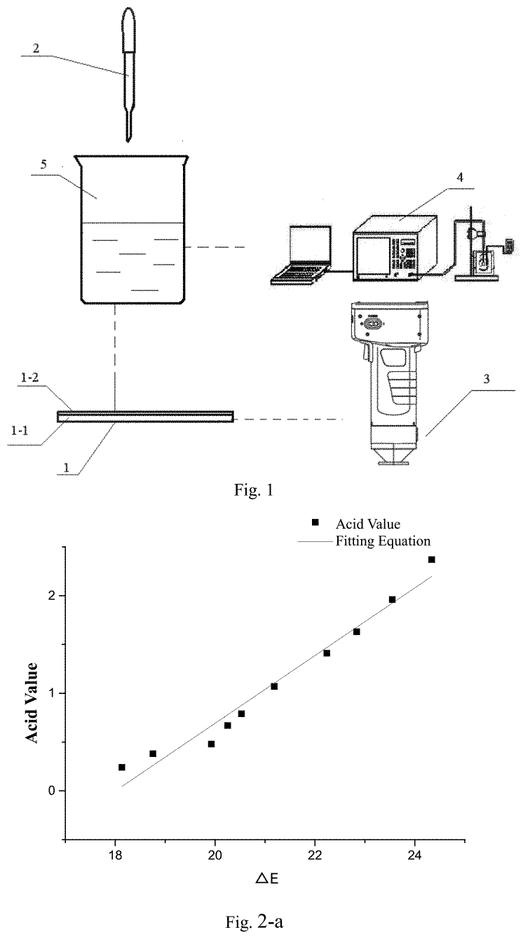

Reference Signs: 1 rapid detection test paper for quality of fried oil; 1-1 carrier; 1-2 color developing layer; 2 dropper; 3 color difference meter; 4 dielectric analyzer; and 5 sample to be detected.

### DETAILED DESCRIPTION

### Embodiment 1

Establishment of correlation among the quality index of fried oil, the color difference value ΔE(x) of rapid detection test paper and the dielectric eigenvalue ε(x) of the fried oil:

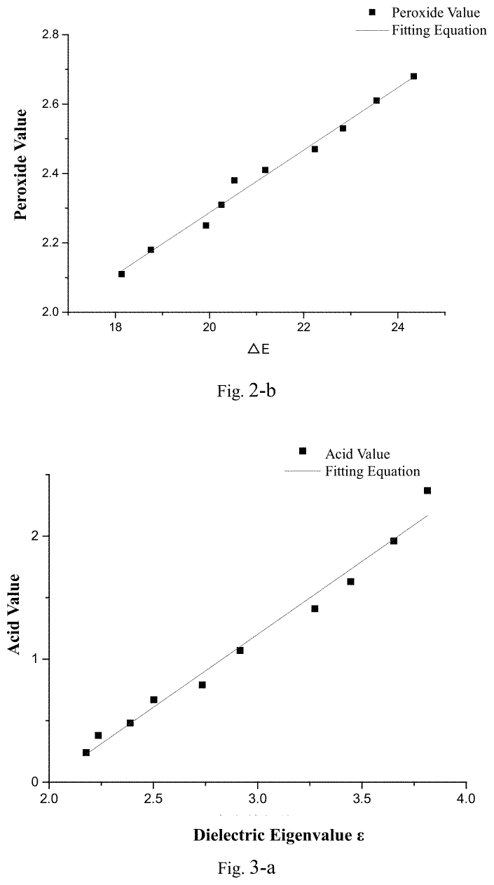

5 L of soybean oil is poured into an electric fryer; the temperature is controlled at (200±2)° C. for frying without material; 300 mL of sample is taken every 8 h within the 80 h of frying; 10 standard samples are taken to measure the acid values, the peroxide values and the dielectric properties of the fried oil samples; the standard samples are developed by using the rapid detection test paper to analyze the color differential value ΔE(x); correlation analysis is conducted on the obtained acid values of the fried oil, the quality index values of the peroxide values and the color difference value ΔE(x) of the rapid detection test paper,

wherein the analysis results of the acid values and the color difference value ΔE(x) of the fried oil are shown in FIG. 2-a, and the analysis results of the quality index values of the peroxide values and the color difference value ΔE(x) are shown in FIG. 2-b; correlation equations are respectively obtained: y=0.346x−6.247 and y=0.090x+0.486, and the correlation coefficients R² are respectively 0.988 and 0.985.

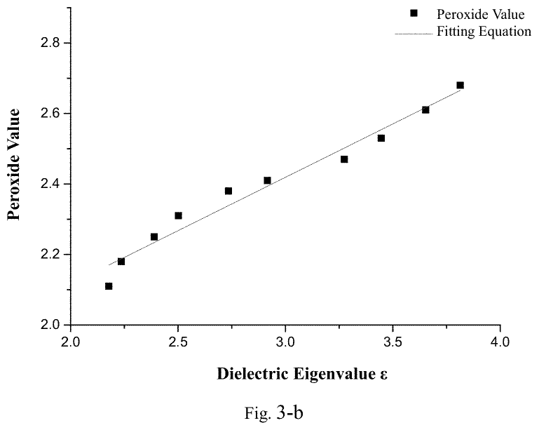

The correlation is established among the acid values of the fried oil, the quality index values of the peroxide values and the dielectric eigenvalue ε(x) of the fried oil. The analysis results of the acid values of the fried oil and the dielectric eigenvalue ε(x) are shown in FIG. 3-a; and the analysis results of the quality index values of the peroxide values and the dielectric eigenvalue ε(x) are shown in FIG. 3-b. Correlation equations are respectively obtained: y=1.186x−2.356 and y=0.303x+1.510, and the correlation coefficients R² are respectively 0.979 and 0.975.

Therefore, it indicates that the detection of the acid value and the peroxide value of the fried oil is more intuitive and accurate through the combination of the color difference value of the color developing test paper and the dielectric properties of the fried oil.

### Embodiment 2

Rapid detection of deterioration degree of fresh palm oil and fried palm oil

(1) 1-2 mL of fresh palm oil and 1-2 mL of fried palm oil are respectively taken with suckers, uniformly applied to the self-made rapid detection test paper for quality of the fried oil, and colored after waiting for 10 s; the operation is repeated for each sample for 3 times;

(2) dielectric constants of the samples in the step (1) are determined with a network analyzer, and specific numerical values are respectively 2.178±0.004 and 2.916±0.005;

(3) color difference analysis is conducted on test paper strips colored in the step (1); by combining with the dielectric constant data of the fried oil, the actual data of the acid value and the peroxide value of the fried oil are obtained by the correlation equation among the color difference value, the dielectric constant value, the acid value and the peroxide value of the fried oil; and then the deterioration degree of the fried oil is rapidly detected.

Detection results show that, the color developing test paper of the fresh palm oil is dark blue, and the color developing test paper of the fried palm oil is blue-green. Through the correlation equation between the color difference value and the dielectric constant, the color difference values of the developed colors of the fresh palm oil and the fried palm oil are respectively 17.65±0.04 and 18.19±0.03, acid values are respectively 0.25±0.01 mg KOH/g and 1.06±0.01 mg KOH/g, and peroxide values are respectively 2.12±0.02 and 2.36±0.01 meq/kg.

Research results show that, the rapid detection method of the deterioration degree of the fried oil can accurately, rapidly and conveniently detect the deterioration degree of the palm oil in the frying process.

### Embodiment 3

Rapid detection of deterioration degree of fresh soybean oil and fried soybean oil

(1) 1-2 mL of fresh soybean oil and 1-2 mL of fried soybean oil are respectively taken with suckers, uniformly applied to the self-made rapid detection test paper for quality of the fried oil, and colored after waiting for 10 s; the operation is repeated for each sample for 3 times;

(2) dielectric constants of the samples in the step (1) are determined with a network analyzer, and specific numerical values are respectively 2.446±0.003 and 3.746±0.007;

(3) color difference analysis is conducted on test paper strips colored in the step (1); by combining with the dielectric constant data of the fried oil, the actual data of the acid value and the peroxide value of the fried oil are obtained by the correlation equation among the color difference value, the dielectric constant value, the acid value and the peroxide value of the fried oil; and then the deterioration degree of the fried oil is rapidly detected.

Detection results show that, the color developing test paper of the fresh soybean oil is indigo blue, and the color developing test paper of the fried soybean oil is yellow-green. Through a color difference meter and a detection analysis program, the color difference values of the developed colors of the fresh soybean oil and the fried soybean oil are respectively 17.85±0.02 and 18.99±0.04, acid values are respectively 0.54±0.01 mg KOH/g and 2.25±0.02 mg KOH/g, and peroxide values are respectively 2.36±0.02 and 2.57±0.01 meq/kg.

Research results show that, the rapid detection method of the deterioration degree of the fried oil can accurately, rapidly and conveniently detect the deterioration degree of the soybean oil in the frying process.

1. A rapid joint detection device for deterioration degree of fried oil, comprising rapid detection test paper for quality of fried oil, a dropper, a color difference meter, a dielectric analyzer and a sample to be detected, wherein the sample to be detected is connected with the dielectric analyzer; the dropper is used for sucking the sample to be detected and dropping the sample to be detected on the rapid detection test paper for quality of fried oil for detection; the rapid detection test paper for quality of fried oil is connected with the color difference meter.

2. The rapid joint detection device for deterioration degree of fried oil according to claim 1, wherein the rapid detection test paper for quality of fried oil comprises a carrier and a color developing layer covered on the carrier.

3. A preparation method of the rapid detection test paper for quality of fried oil according to claim 2, comprising the following steps:
(1) carrier preparation: using a transparent frosted plastic sheet as the carrier;
(2) preparation of the color developing layer: weighing 5 g of G-type thin-layer chromatography silica gel, adding 20 mL of sodium carboxymethyl cellulose solution with a mass concentration of 0.3% to the silica gel, and evenly grinding in a mortar; uniformly applying the ground solution to the carrier in the step, placing for 3-5 hours at room temperature to dry, and finally immersing the carrier in a bromocresol green indicator for dyeing, to obtain the rapid detection test paper for quality of fried oil.

4. A rapid joint detection method for deterioration degree of fried oil for the detection device of claim 1, adopting color development-dielectric joint detection and comprising the steps:
(1) determining the dielectric eigenvalue ε of the sample to be detected by the dielectric analyzer; analyzing and predicting the quality of the sample to be detected; and reducing the identification accuracy of the color developing test paper of the fried oil by a correlation equation established among an acid value of the fried oil, a peroxide value and the dielectric eigenvalue of the fried oil established in an early test;
(2) taking 1-2 mL of the sample to be detected with the dropper, evenly applying to the rapid detection test paper for quality of fried oil, and waiting for 10 s to develop a color; observing the color change of the rapid detection test paper for quality of fried oil, and reading a color difference value through the color difference meter;
(3) rapidly detecting the deterioration degree of the fried oil through the obtained actual data of the acid value of the fried oil, the peroxide value and the color difference value ΔE(x).

5. The rapid joint detection method for deterioration degree of fried oil according to claim 4, wherein correlation analysis is conducted on the acid value of the fried oil, the peroxide value and the color difference value ΔE(x) to obtain the correlation equation, wherein a linear equation obtained by using the acid value of the fried oil as a y axis and the color difference value ΔE as an x axis is y=0.346x−6.247, and a correlation coefficient R² is 0.988; a linear equation obtained by taking the peroxide value as the y axis and the color difference value ΔE as the x axis is y=0.090x+0.486, and a correlation coefficient R² is 0.985;
the correlation is established among the acid value of the fried oil, the peroxide value and the dielectric eigenvalue ε(x) of the fried oil to obtain a correlation equation, wherein a linear equation obtained by using the acid value of the fried oil as a y axis and the dielectric eigenvalue ε as an x axis is y=1.186x−2.356, and a correlation coefficient R² is 0.979; a linear equation obtained by taking the peroxide value as the y axis and the dielectric eigenvalue ε as the x axis is y=0.303x+1.510, and a correlation coefficient R² is 0.9.
